(19) United States
(12) Patent Application Publication
(10) Pub. No.: US 2008/0001009 A1
(43) Pub. Date: Jan. 3, 2008

(54) Point and rinse faucet connector

(76) Inventor: Barbara Sherise Young, Beaumont, TX (US)

Correspondence Address: DELPHINE M. JAMES, 2656 SOUTH LOOP WEST #170, HOUSTON, TX, 77054, US

(21) Appl. No.: 11/477,084

(22) Filed: Jun. 28, 2006

(51) Int. Cl. B05B 9/01; B05B 15/08; B05B 1/00

(52) U.S. Cl. 239/526; 239/587.1; 239/600

(57) ABSTRACT

The present invention comprises a collapsible connector member, an elongated flexible hose member, and a sprayer device. The collapsible member is attached to one end of the flexible hose member and the sprayer device is attached to the opposing end of the flexible hose member. The collapsible connector member is adapted to connect to any type, size, or shape of faucet or shower head, and the sprayer device is for directing the flow of water from the faucet.

### BACKGROUND

The present invention relates to connector device for a faucet and more particularly, a connector device that can be easily attached and detached to any type of faucet.

Generally, kitchen and bathroom faucets can only provide water to the sink where the faucet is mounted. However, during cleaning the bathroom or kitchen it is desirable to spray water a distance from where the sink is located.

US. Pending Patent No 2003/0042337A1 published Mar. 6, 2003 discloses a connector for a faucet. This device threadingly engages with a water faucet. However, the present invention provides a uniquely designed connector device.

### SUMMARY

One of the main objectives of the present invention is to provide a connector to a faucet wherein the connector comprises a collapsible connector member which can be adapted to easily attach and detach from any type, size or shape of faucet or shower head. The present invention comprises a collapsible connector member, an elongated flexible hose member, and a sprayer device. The collapsible member is attached to one end of the flexible hose member and the sprayer device is attached to the opposing end of the flexible hose member.

Further advantages of the present invention will become apparent after reading the detailed description in conjunction with the attached drawings.

### BRIEF DESCRIPTION OF THE DRAWINGS

FIG. 1 is a frontal perspective view of the present invention.

FIG. 2 is an exploded view of the present invention illustrating the hose extension member.

FIG. 3 is an enlarged side view illustrating the present invention connected to a faucet.

FIG. 4 is an alternative embodiment of the present invention illustrating connector member and sprayer device removably attached to the hose member.

FIG. 5 is a side view illustrating the detergent dispenser and an adjustable setting for the trigger sprayer.

### DETAILED SPECIFICATIONS

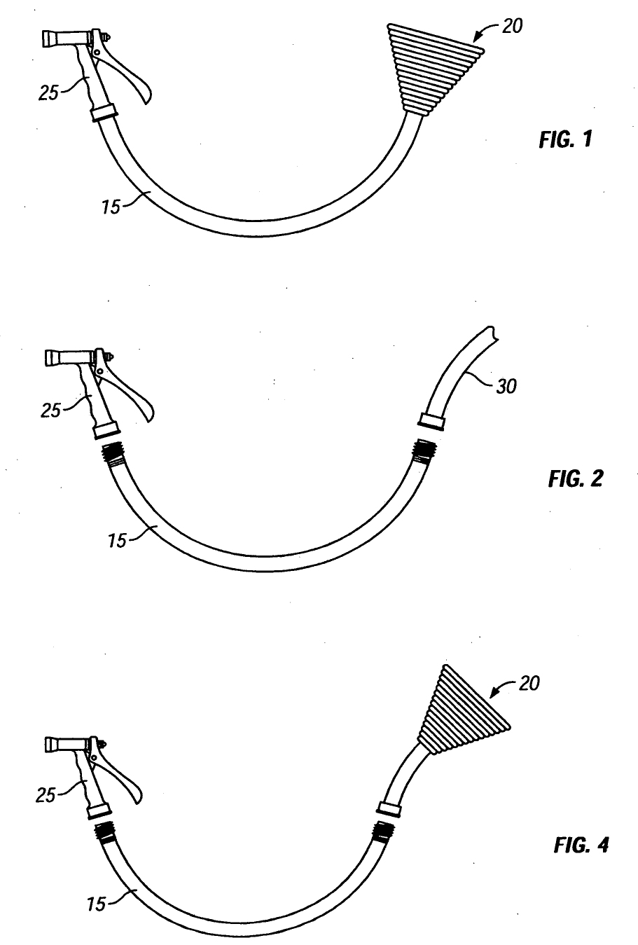

Referring to FIG. 1, there is shown a frontal side view of the present invention, a faucet connector (10). The faucet connector (10) further comprises a hose member (15) having a sprayer device (15) connected at one end and a collapsible connector member (20) connected at the opposing second end.

The hose member (15) is an elongated cylindrical shape flexible tube which can vary in length and diameter. As shown in FIG. 1, affixed to one end of hose member (15) is sprayer device (15) and affixed to the opposite second end of hose member (15) is collapsible connector member (20). Hose member (15) can be made of flexible plastic material or metal material such as aluminum.

Alternatively, as depicted in FIG. 4, sprayer device (15) and collapsible connector member (20) can be adapted to be removably connected to each end of the hose member (15). One method of removably connecting to hose member (15) is conventional threading means. As depicted, conventional male threading can be incorporated into each end of the hose member (15). For connection to hose member (15) mating female threads can be incorporated into sprayer device (15) and the collapsible connector member (20).

Another method of removably connecting to hose member (15) is conventional quick release mating coupling devices (not shown). Conventional male cap coupling devices can be incorporated into each end of the hose member (15). For connection to hose member (15) mating female cap coupling devices can be incorporated into sprayer device (15) and the collapsible connector member (20).

Additionally, hose member (15) can be adapted with an extension member (30). Extension member (30) is also an elongated cylindrical shape flexible tube corresponding to the type and size of the attaching hose member (15). Extension member (30) is also adapted with fastening means (35) at each end so that it can be easily attached to and detached from the hose member (15).

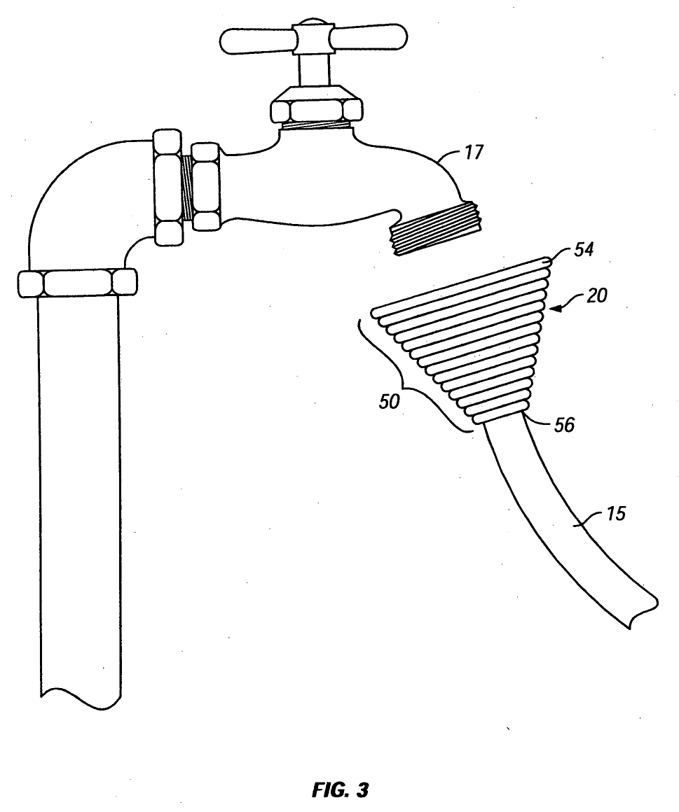

Referring to FIG. 3, there is shown an enlarged top view of collapsible connector member (20). Collapsible connector member (20) includes a substantially conical shape housing (50) defining an interior cavity (52) with an opened first end (54) and an opposing hose connection end (56). Interior cavity (52) is adapted to securely engage onto the faucet or shower head forming a water tight seal. As shown, circumferentially surrounding the housing (50) is a plurality of flexible co-centrically located rings. Each ring varies in decreasing diameter from opened first end (54) to opposing hose connection end (56). The flexibility and the various sizes of the rings allow the connector member (20) to connect to faucets of various sizes and shapes. Additionally, housing (50) is made of a flexible plastic or rubber material which easily expands and decreases in diameter when connecting to the faucet or shower head. Additionally, each ring can be adapted with a sealing member such as an O-ring. The sealing member circumferentially surrounds each ring providing a water tight seal upon attaching the collapsible connector member (20) to the faucet or shower head.

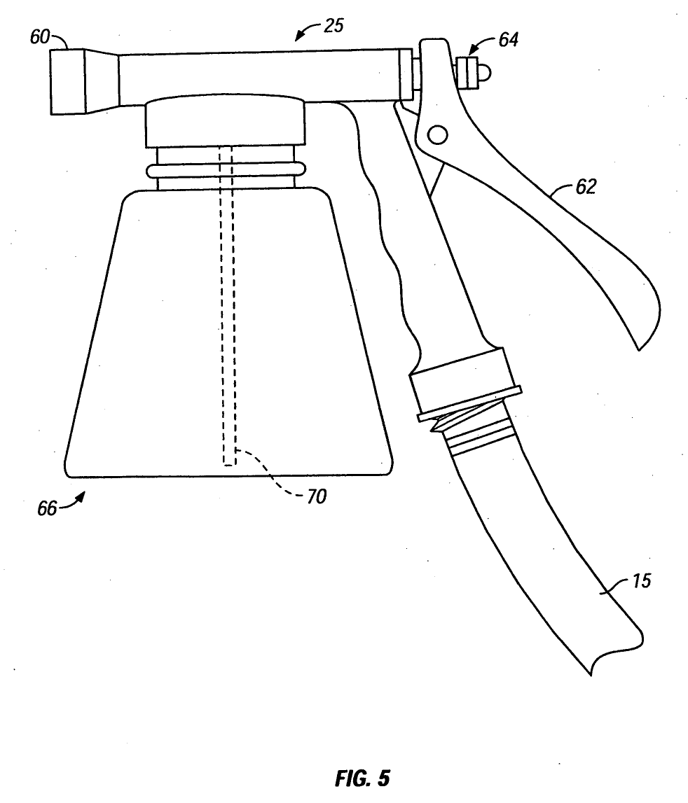

Referring to FIG. 5, sprayer device (15) is conventional and further comprises nozzle (60) and handle (62). Incorporated into nozzle (60) is a one-way directional valve which allows flow of water through hose member (15) in only one direction. Thus, when handle (62) is depressed, water flow from the faucet is directed through hose member (15) into nozzle (60). Additionally a control mechanism (64) can be operationally coupled to sprayer device (15). Control mechanism (64) allows the varying of the water pressure flow through nozzle (60).

Additionally, a small detergent dispenser (66) can be removably attached to sprayer device (15). Dispenser (66) further includes a small container having an opened top with a cavity therein. As depicted, the opened top of dispenser 66 can be removably attached to sprayer device (15). Tube member (70) is situated within the cavity of dispenser 66 and extends upward coupled to nozzle (66). When handle (62) is depressed, cleaning fluid contained within dispenser (66) is directed through tube member (70) into nozzle (60) and incorporated into the water flow through nozzle (60). Control mechanism (64) can be adapted with an on/off switch to control the flow of the detergent from dispenser (66). As illustrated in FIG. 5, The sprayer handle (62) can be located on the bottom or located on the top.

What is claimed is:

1. A device for connecting to a water faucet, the device comprising:
an elongated tubular hose member of varying in size and diameter, the hose member being defined by a first end and an opposite opposing end;
a sprayer mechanism affixed to the first end of the host member, the sprayer mechanism for directing water flow from the water faucet through the sprayer mechanism; and
a collapsible connector member attached to the opposing second end of the hose member, the connector member defined by an opened end and a second end coupled to the hose member, the collapsible connector member having a substantial conical shape decreasing in diameter from the opened end to the second end such that the opened end is adapted to form a water tight seal when attached to the water faucet of various sizes and shapes.

2. The device of claim 1 wherein the collapsible connector member is made of a flexible material.

3. The device of claim 2 wherein the collapsible connector member further comprises a plurality of concentrically located rings extending from the opened end to the second end.

4. The device of claim 3 wherein at least one ring is adapted with sealing means.

5. The device of claim 1 further comprising a control mechanism for varying the pressure of the water flow through the sprayer device from the faucet.

6. The device of claim 1 further comprising:
a dispenser having a small container with an opened top;
the opened top adapted to be removably coupled to the sprayer device; and
a small elongated tube situated with the container, the elongated tube having an upper end coupled to the sprayer device allowing detergent to flow from the container through the tube into the water flow.

7. The device of claim 1 further comprising:
an elongated tubular hose member of varying in size and diameter, the hose member being defined by a first end and an opposite opposing end;
a sprayer mechanism affixed to the first end of the host member, the sprayer mechanism for directing water flow from the water faucet through the sprayer mechanism;
a collapsible connector member defined by an opened end and a second end coupled to the hose member, the collapsible connector member having a substantial conical shape decreasing in diameter from the opened end to the second end such that the opened end is adapted to form a water tight seal when attached to the water faucet of various sizes and shapes.
a first coupler member attached to the opposing second end of the hose member; and
a mating first coupler member attached to the connector member; and
the first coupler member being removable engaged with the mating first coupler member forming a water tight seal.

8. A water faucet connector device comprising:
an extension member having an elongated tubular second hose member of varying length, the second hose member having a size and diameter equivalent to the hose member, the second hose member being defined by a first end and an opposing end;
a first mating coupler member attached to the first end;
a second mating coupler member attached to the second end;
the first coupler member adapted to securely engaged with the connecting member forming a water tight seal; and
and the second mating coupler member adapted to securely engaged with the opposing second end of the hose member.

9. A water faucet connector device comprising:
an elongated tubular hose member of varying in size and diameter, the hose member being defined by a first end and an opposite opposing end;
a sprayer mechanism for directing water flow from the water faucet through the sprayer mechanism;
a collapsible connector member attached to the opposing second end of the hose member, the connector member defined by an opened end and a second end coupled to the hose member, the collapsible connector member having a substantial conical shape decreasing in diameter from the opened end to the second end such that the opened end is adapted to form a water tight seal when attached to the water faucet of various sizes and shape; and
a first coupler member attached to the first second end of the hose member;
a mating first coupler member attached to the sprayer device; and
the first coupler member being removable engaged with the mating first coupler member forming a water tight seal.

10. The device of claim 9 further comprising:
an extension member having an elongated tubular second hose member of varying length, the second hose member having a size and diameter equivalent to the hose member, the second hose member being defined by a first end and an opposing end;
a first mating coupler member attached to the first end;
a second mating coupler member attached to the second end;
the first coupler member adapted to securely engaged with the sprayer device forming a water tight seal; and
and the second mating coupler member adapted to securely engaged with the first of the hose member

11. The device of claim 10 further comprising:
a first coupler member attached to the opposing second end of the hose member; and
a mating first coupler member attached to the connector member; and
the first coupler member being removable engaged with the mating first coupler member forming a water tight seal.
